(19) United States
(12) Patent Application Publication
(10) Pub. No.: US 2018/0089697 A1
(43) Pub. Date: Mar. 29, 2018

(54) Secure Offline Playing of Media Files

(71) Applicant: Robert Marc Zeidman, Cupertino, CA (US)

(72) Inventor: Robert Marc Zeidman, Cupertino, CA (US)

(73) Assignee: Firtiva Corporation, Cupertino, CA (US)

(21) Appl. No.: 15/809,514

(22) Filed: Nov. 10, 2017

Related U.S. Application Data
(63) Continuation of application No. 14/634,728, filed on Feb. 28, 2015.

(51) Int. Cl. G06Q 30/00; G06Q 30/02; G06F 21/10

(52) U.S. Cl. CPC G06Q 30/0185; G06Q 30/0255; G06Q 2220/12; G06F 2221/0753; G06F 21/10

(57) ABSTRACT

A system and method that allows media files to be downloaded to a client device via the Internet and played without commercial interruption, even when the local device is no longer connected to the Internet. The viewing habits of users of the invention are recorded on the client device, and when the device is connected to the Internet, the user's viewing habits are uploaded to a web server database. Companies that sponsor the content can use the information in the database to offer targeted advertisements, discounts, and various special offers to targeted users at a later time. The users can also access a central database, which sends back to the user targeted advertisements, coupons, discounts, contests, and other enticements to purchase products from companies that sponsored content that they viewed.

### PRIORITY APPLICATION

This is a continuation/divisional patent application drawing priority from U.S. patent application Ser. No. 14/634,728; filed Feb. 28, 2015. This present patent application draws priority from the referenced patent application. The entire disclosure of the referenced patent application is considered part of the disclosure of the present application and is hereby incorporated by reference herein in its entirety.

### BACKGROUND OF THE INVENTION

Producers of media content such as videos, music, and books want to reach as large an audience as possible. A larger audience means more recognition for the content and for the creators of the content. It also may mean more money goes to those involved in creating the content. Advertisers want to reach the consumers of the content and sell them goods. They are willing to pay significant amounts of money for access to these viewers. Consumers want to get content for as little cost as possible and generally do not like the interruption of their content by advertisements such as commercials, pop-up ads, and banner ads, whether these ads are on a computer, a movie screen, a television screen, a smartphone, or a tablet.

The desires of these three different groups—viewers, producers, and sponsors—are often at odds. In recent years, technology has been developed to assist one group fulfill their desires at the expense of one or more of the other two groups. Then legal and technical means are used by one of the disadvantaged parties to defeat this new technology. One example of a technological solution is the digital video recorder (DVR) that allows a viewer of television shows to record them and automatically or manually skip commercials. While this satisfies the desires of viewers, it defeats the desires of sponsors. This technology may be a benefit to producers who want their content viewed without interruption or distraction, or it may be to the detriment of producers who want to be paid for their work and who lose revenue from sponsors whose advertisements are being skipped. In all cases, sponsors are at a disadvantage because their advertisements are not seen.

In response to the automatic commercial skipping feature of certain DVRs, some companies took legal action against DVR manufacturers and providers for copyright infringement and breach of contract. See e.g., Fox Broadcasting Co. v. Dish Network, LLC. Some DVR manufacturers and distributors reached agreements with content providers to disable the use of automatic commercial skipping features in their DVRs, although viewers could still manually skip commercials. This commercial skipping technology pushed sponsors to place advertisements at the bottom of the television screen while shows are playing—often animated people and cartoons that pop up and create an annoying distraction for the viewer.

Similar scenarios have occurred with movies in theaters that now try to maximize revenue by showing long series of ads and previews before the main feature, usually to the annoyance of moviegoers. Banner ads and pop-ups now clutter computer screens at most websites, particularly those that give access to “free” content. Smartphone apps also often include pop-up ads that sometimes cannot even be clicked away, and that block the content being viewed.

To access content without advertisements, business models like pay-TV cable networks such as HBO and Showtime and pay-audio services such as Apple iTunes allow customers to pay for advertisement-free content, but viewers tend to share the purchased content with friends or, worse, sell the content to others despite not having the rights to do so. This form of piracy denies the money to content producers that they need to continue to create content. This form of piracy also denies the money to the sponsors of the content whose advertisements are cut out entirely or remain but cannot be tracked to the viewer. Sophisticated technical solutions have been developed to encrypt media files (called digital rights management or “DRM”) so that only the party that purchased the content can access it, but computer hackers continue to develop equally sophisticated technological methods to break such encryption. This led to Congress passing the Digital Millennium Copyright Act in 1998 that created serious penalties for anyone who produces and disseminates technology, devices, or services intended to circumvent DRM measures that control access to copyrighted work. The DMCA also penalizes anyone who actually circumvents such measures.

The situation is a never-ending war on the dual battlefields of law and technology. All weapons in this war are beneficial to one or two of the three parties involved—viewers, producers, and sponsors—while detrimental to the remaining party or parties. What is needed is a solution where all parties benefit. A win-win-win for all involved. A lasting peace.

### SUMMARY OF THE INVENTION

The present invention allows media content to be downloaded and accessed while the user is not connected to the Internet, yet restricts access to registered users and also tracks user viewing habits. The service that enables the invention is called a media management service.

The present invention allows the user to download a media file to a smartphone, tablet, laptop, or other network-connected device, where the media file includes but is not limited to a video file, music file, or e-book file. In one embodiment, the media file is encrypted such that the user must get the decryption key from a network-connected computer server that verifies that the user is a registered user or, if not already registered, the user is required to register at a website. The encryption key is downloaded from the network-connected computer server to the registered user's device, where it is stored and is used to decrypt the media file at any time including a time when the user is not connected to the Internet. As the user accesses the media file, information about the user's viewing habits are stored on the user's device. At a later time when the user connects to the Internet, the user's viewing habit information is uploaded to the Internet-connected computer server.

The present invention allows content to be broadcast without commercial interruption, yet lets the company or companies that sponsor the content to offer advertisements and discounts and various special offers to the viewers at a later time of their own choosing, typically on a second screen. For example, the user may watch a television show on a tablet computer while on a plane without an Internet connection, while incentives to purchase products are delivered via email to their home computer or by text message to their phone at a later time.

The present invention allows the recording of information about the user's viewing habits and delivers that information to a web server where it is saved in a database. The information in the database can be purchased by a company that desires to know the viewing habits of people in certain age groups, genders, in certain sections of the country, and/or having particular interests and hobbies so that they can determine which ones are most likely to purchase their products. Alternately the information in the database can be purchased by companies that desire to know the age groups, locations, genders, interests and hobbies of people watching particular content so that they can determine which content appeals to people who are most likely to purchase their products.

The present invention allows the viewer to access a central database at any time, which provides advertisements, coupons, discounts, contests, and other incentives to purchase products, based the viewer's information and whether the viewer watched content that was sponsored by a particular advertiser.

Sponsoring companies pay to have the content delivered over the system in order to get information about the viewers of the sponsored content and in order to send these viewers targeted incentives to purchase their products. Content providers keep a share of the money spent by the sponsors. The company maintaining the media management service also keeps a share of the money spent by the sponsors. The viewers watch content of their choosing without interruptions by commercials, pop-up ads, and banner ads. The viewers can watch content at no charge to them as long as they allow sponsors to send them incentives, typically on a second screen and/or at a later time. Because these incentives are for products that have been determined to likely be wanted or needed by the viewers, viewers will appreciate the incentives rather than find them to be an annoyance.

Another benefit of the present invention is that because viewers can obtain content at no charge, there is no incentive for piracy. Why obtain something illegally for free when you can obtain it legally for free? And the illegal version does not come with any incentives while the legal version also comes with coupons and discounts on really cool stuff.

### BRIEF DESCRIPTION OF THE DRAWINGS

FIG. 1 shows a media server connected to a client device via the Internet, in accordance with one embodiment of the present invention.

FIG. 2 is a flow chart for the process of downloading a media file from a media server, in accordance with one embodiment of the present invention.

FIG. 3 is a flow chart for the process of playing a media file on the client while it is not connected to the Internet, in accordance with one embodiment of the present invention.

FIG. 4 shows the interaction between the media server and the client for downloading a media file for offline play, in accordance with one embodiment of the present invention.

FIG. 5 is a flow chart for the process of sending information back to a web server once an Internet connection has been established and after a media file has been played offline, in accordance with one embodiment of the present invention.

FIG. 6 is a flow chart for the process of sending incentives to a user to purchase goods from the sponsors of the media file that the user played.

### DETAILED DESCRIPTION

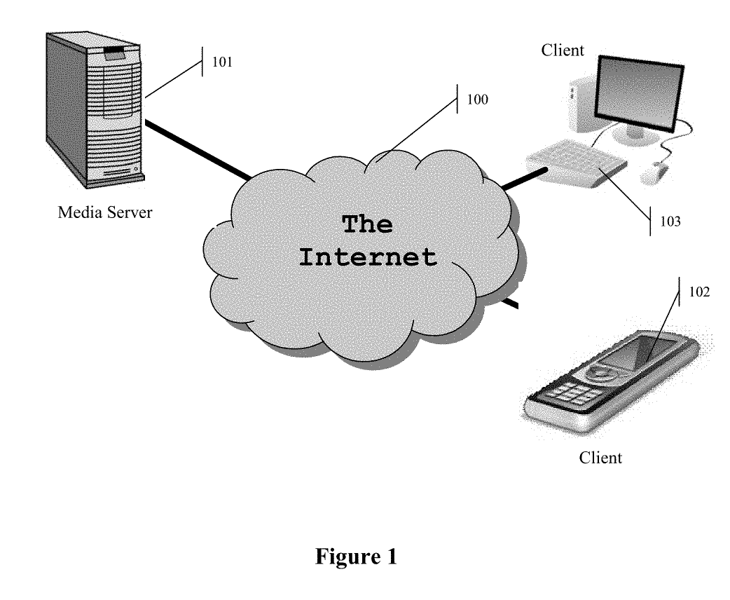

One embodiment of the present invention is illustrated in FIG. 1, which shows Media Server computer 101 connected to the Internet 100. It also shows Client 102 and Client 103 connected to the Internet 100. Media Server 101 contains a number of media files including but not limited to audio files and video files. Media Server 101 may also contain other media files such as electronic newspapers, magazines, or books. Client 102 and Client 103 are client devices that connect to the Internet 100 and request a download of a media file from Media Server 101.

One of ordinary skill in the art would recognize that the Internet 100 may be replaced with any network including but not limited to a local area network (LAN), intranet, or wide area network (WAN) that may be wired or wireless. One of ordinary skill in the art would also recognize that Client 102 and Client 103 may be any kind of network client device including but not limited to a mobile phone, tablet computer, laptop computer, desktop computer, set top box, or any Internet-connectable appliance.

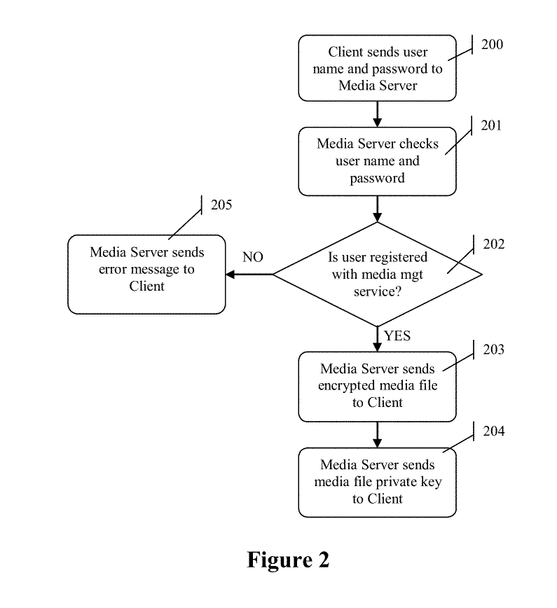

When Client 102 is connected to the Internet 100 and the user requests a media file from Media Server 101, a process connects the Client 102 to Media Server 101 to confirm that the user has registered with the media management service. This process is illustrated in FIG. 2 according to one embodiment of the present invention. At block 200, the Client 102 sends the user's media management service credentials, comprising a user name and password, to the Media Server 101. At block 201, the Media Server checks a database containing all user names and passwords. At block 202, the Media Server determines whether the user name and password are valid for a media management service user. If not, an error message is sent to the Client 102 in block 205. The user can then decide whether or not to re-enter the information. At block 202 if the user is registered with the media management service, an encrypted Media File is sent from the Media Server 101 to Client 102 at block 203. At block 204 the Media Server sends a private encryption key to the Client 102 that can be used to decrypt the encrypted media file.

According to one embodiment of the present invention, a media file in a standard format such as MP3 or MP4 or JPEG is encrypted using a standard private key encryption method—such as Twofish, Serpent, AES (Rijndael), Blowfish, CAST5, RC4, 3DES, Skipjack, Safer+/++, or IDEA.

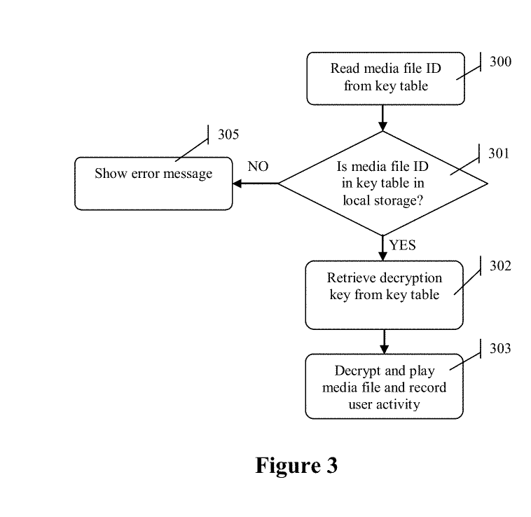

When the user is not connected to the Internet, the process for playing a media file on the Client 102 is shown in FIG. 3 according to one embodiment of the present invention. In block 300, a key table stored in the client local storage is searched for the media file ID value.

One embodiment of a key table would look like this, containing the title, name, ID, and decryption key for each media file:

| Media File Title | Media File Name | Media File ID | Media File Decryption Key |
|---|---|---|---|
| 50 First Dates | 50First.mp4 | 17 | A9DD9EE6F001101BC8BA1234 |
| Fail Safe | FailSafe.mp4 | 239 | 1013BEC0228472DEF8898E4E5 |
| Galaxy Quest | GalaxyQuest.mp4 | 393 | 82BC7E8DA9EB762357AAAB20 |
| Good Intentions | GoodIntentions.mp4 | 467 | 7EB56717823DEFFABBC7C7C7 |
| Horror Flick | HorrorFlick.mp4 | 921 | EF7345000176AAB6E7889CCC |
| Schindler's List | Schindler.mp4 | 1988 | 7540EFFEAA745A99987987BC |

This local storage may be a hard disk, a solid state memory, or other nonvolatile memory. The table may be in a file or in a database. The key table contains a list of media file IDs for media files that have been downloaded by the user. Each media file ID has a corresponding encryption key that has also been downloaded. In block 301, it is determined whether the particular media file ID is found in the key table. If not, block 305 presents an error message to the user on the client. The error message may ask the user to connect to the Internet to download the file. It may also ask the user to register for the media management service if the user is not already registered.

If the media file ID is found in the key table at block 301, the corresponding decryption key is retrieved from key table at block 302. At block 303 the media file is decrypted and played on the client device using a standard media player. A decrypted copy of the media file is not stored on the client. While the media file is playing, user activity information is recorded locally at block 303 including, but not limited to, the time of day, which sections of the file are being played, the number of times the file is being played, where the user starts playing within the file, where the user pauses playing within the file, and where the user stops playing within the file.

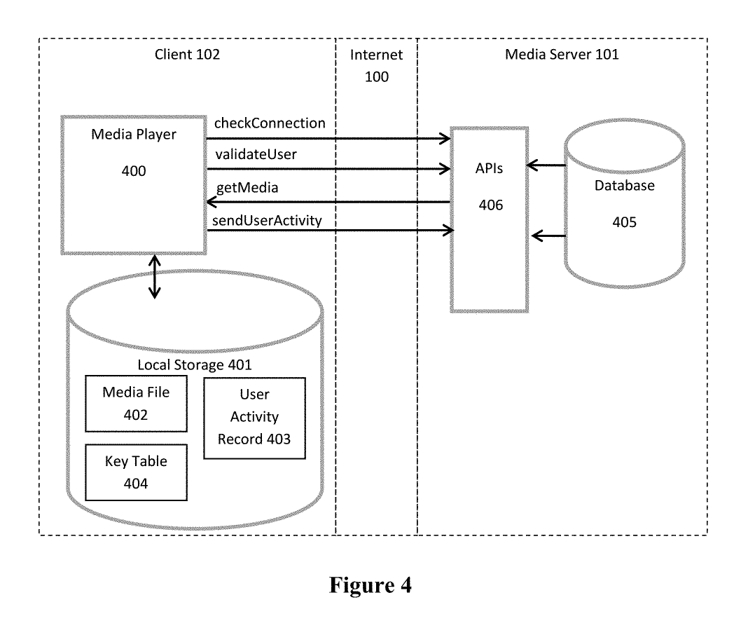

FIG. 4 shows the interaction between the Media Server 101 and the Media Player application 400 on the Client 102 for downloading a media file for offline play. On the Client 102, the Media Player 400 is an application that communicates with the server over the Internet 100, downloads the user-requested Media File 402 and stores it in Local Storage 401, maintains the Key Table 404, plays the Media File 402, and records user activity in the User Activity Record 403. The Key Table 404 contains title, name, ID, and decryption key for the downloaded media files. The User Activity Record 403 contains the user's media management service account username and password as well as various metrics about the user's viewing habits. The User Activity Record 403 cannot be modified by the user and is secured from attempts to change it or read it. For media files to be played by Media Player 400, the user must be have an active media management service account. When the user does not currently have an Internet connection, the user's media management service credentials, comprising user name and password, are checked against the media management service credentials stored in the User Activity Record 403. There is a timeout measured in days (represented by constant MAX_LOCAL_DAYS), after which the user's media management service credentials that are stored in the User Activity Record 403 are cleared, and the user must connect to the Internet to validate the user's account. Note that only the username and password are cleared; the rest of the user activity information is stored until it has been sent to the Media Server 101.

When the Client 102 is connected to the Internet 100, the following process takes place:
1. Client 102 checks for an active Internet connection by calling the application program interface (“API”) checkConnection( ) among the set of APIs 406 on the Media Server 101. This API is a simple ping type method. It establishes a secure, encrypted connection with the Media Server 101 using the HTTPS protocol and a standard public key encryption communication method such that all subsequent communications are encrypted.
2. Client 102 then authenticates the user by checking the username and password that the user enters with those stored on the Media Server 101 via the validateUser(username, password) API. An authentication process on the Media Server 101 confirms or denies that the username and password represent a user who is registered with the media management service.
3. If the user is not registered, Media Player 400 advises the user that the username and password are incorrect. Media Player 400 then prompts the user for the username and password again. If the user enters such information a certain number of times (represented by constant MAX_LOGIN_ATTEMPTS) and if each attempt fails, the account is blocked from further attempts. In order to unblock the account, the user must go to the media management service web site and reset the password using a typical secure password reset process such as answering a secret question or verifying a credit card number.
4. Media Player 400 uses the getMedia(username, content_id) API to transfer the Media File 402 that corresponds to content_id from the Media Server 101 to the Client 102 and into the local storage 401. This API also returns a private decryption key associated with the Media File 402 from the Media Server 101 to the Client 102 that is then stored in Key Table 404.
5. At some later time, the user requests that the Media Player 400 play downloaded Media File 402. The Media Player 400 calls the local playMedia( ) function, which changes the user activity state from “idle” to “playing” in User Activity Record 403. This function also begins playback by decrypting Media File 402, using the corresponding decryption key read from Key Table 404 as Media File 402 plays, in such a way that a decrypted media file is not left in the Local Storage 401.
6. Media Player 400 uses the local trackUserActivity( ) function to record the user activity in the User Activity Record 403 while the Media File 402 is being played, including, but not limited to, the date, the time of day, which sections of the file are being played, the number of times the file is being played, where the user starts playing within the file, where the user pauses playing within the file, and where the user stops playing within the file.
7. Media Player 400 periodically checks for an Internet connections using the checkConnection( ) API. When an Internet connection is re-established, Media Player 400 uses the validateUser(username, password) API to verify that the user is a registered media management service user. This further verifies that the username and password are valid and have not been changed while the Client 102 was offline. If the user is not a registered media management service user, Media Player 400 will stop playing Media File 402, if it is currently playing, and will signal the user that the username and password are incorrect. Media Player 400 then will prompt the user for the username and password again. If the user is a registered media management service user, Media Player 400 uses the sendUserActivity(username, content_id, activity_record) API to send the User Activity Record 403 back to Media Server 101 to be stored on the Database 405.

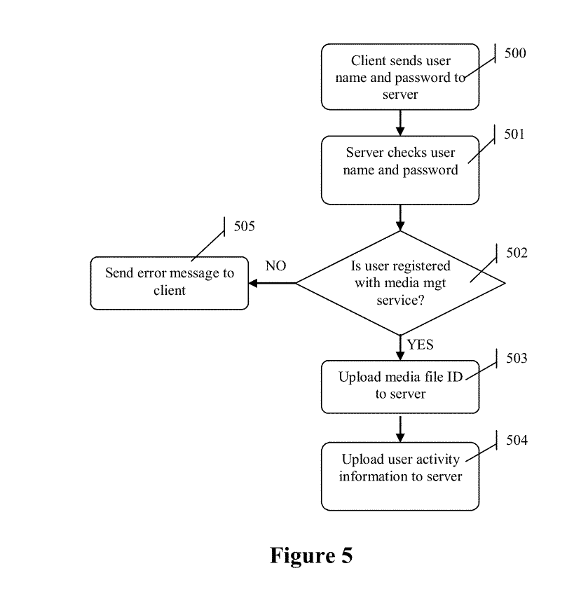

FIG. 5 is a flow chart for the process of sending information back to the media management service once an Internet connection has been reestablished and after a media file has been played offline, in accordance with one embodiment of the present invention. At block 500 the Client 102 sends the user's media management service credentials, comprising user name and password, which is stored locally on the Client 102, back to the Media Server 101, which checks the user name and password with those of users registered with the media management service at block 501. At block 502, the Media Server 101 determines whether the user name and password represent a registered user of the media management service. If not, an error message is sent to Client 102 at block 505. Otherwise, at block 503 the Media Server 101 coordinates with the Client 102 to transfer the media file ID of the recently played media file from the Client 102 to the Media Server 101. At block 504 the user activity information that was recorded on the Client 102 while the user was playing the media file offline is transferred to Media Server 101 so that the media management service can add that information about the habits of the particular user to the information that it already has stored for that user.

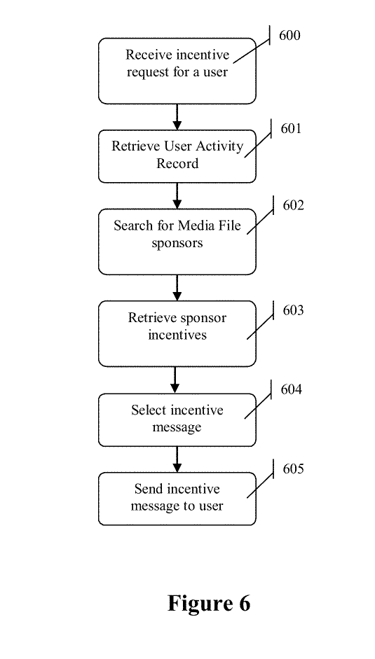

FIG. 6 is a flow chart for the process of sending incentives to a user to purchase goods from the sponsors of the media file that was played by the user. Execution starts in block 600 when a request for an incentive is received by Media Server 101. In one embodiment, requests are sent by the system at regular time intervals. In another embodiment, requests are sent by sponsors of media files at times of the sponsors' determination. One of ordinary skill in the art will understand that there are many different ways to initiate a request to send an incentive to a user.

At block 601 the User Activity Record in Database 405 of Media Server 101 is retrieved. In block 602, Database 405 is searched to determine which advertisers have sponsored which media files. In block 603, specific incentive messages are retrieved from the Database 405 based on retrieved User Activity Record. In block 604, the appropriate incentive message is selected based on the sponsor, the user activity, and the criteria that has been specified by the sponsor. In block 605 the selected incentive message is sent to the user to encourage the user to purchase the sponsor's product. These incentive may be sent to Client 102 or Client 103 or any other device belonging to the user that is connected to the Internet 100.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1.-18. (canceled)

19. A method comprising:
a) determining that a network connection exists;
b) receiving a request via said network to validate user credentials;
c) sending validation of user credentials via said network;
d) sending a media file via said network;
e) receiving via said network a record of user activity that occurred while said media file was being displayed.

20. The method of claim 19 including sending to users incentives to purchase products based on said received record of user activity.

21.-22. (canceled)

23. An apparatus comprising:
a) a processor;
b) a non-volatile memory;
c) a memory containing instructions to cause the processor to
1) determine that a network connection exists;
2) receive a request via said network to validate user credentials;
3) send validation of user credentials via said network;
4) send a media file via said network;
5) receive via said network a record of user activity that occurred while said media file was being displayed.

24. The apparatus of claim 23 wherein said instructions also cause the processor to send incentives to purchase products based on said received record of user activity.
